(19) United States
(12) Patent Application Publication
(10) Pub. No.: US 2004/0233927 A1
(43) Pub. Date: Nov. 25, 2004

(54) Method of controlling communications

(75) Inventor: Takashi Hirosawa, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Renesas Technology Corp., Tokyo (JP)

(21) Appl. No.: 10/679,460

(22) Filed: Oct. 7, 2003

(30) Foreign Application Priority Data
May 23, 2003 (JP) 2003-145742

(51) Int. Cl. H04L 12/413

(52) U.S. Cl. 370/445; 370/252

(57) ABSTRACT

In a network in which a plurality of terminals share one communication channel, signal collision is avoided and a predetermined signal is transmitted with a higher priority level. Priority levels are defined so that they are common to all the packets to be sent by nodes (including terminals and relating devices) on a network. Respective slots that regulate timing for sending out packets are assigned to the respective priority levels. Each slot is determined with reference to a time at which an ongoing packet transmission on the communication channel has finished. The priority levels are allocated in such a manner that packets having higher priority levels (packets to be sent out with higher priority) are allocated to slots having earlier timing.

### BACKGROUND OF THE INVENTION

1. Field of the Invention

The present invention relates to methods of controlling communications in networks in which a plurality of terminals share a communication channel.

2. Description of the Background Art

When a plurality of communication terminals on a network such as LAN (Local area Network) share one communication channel, for example, a signal collision occurs if a plurality of terminals simultaneously attempt to transmit signals (packets) through the communication channel. In order to prevent the collision, signal transmission timing is adjusted between the plurality of terminals to secure a transmission channel; this is called arbitration of transmission rights.

As a conventional arbitration system, a CSMA/CD (Carrier Sense Multiple Access with Collision Detection) system is known (see, for example, Japanese Patent Application Laid-Open No. 2001-251332). In the CSMA/CD system, each terminal checks if the transmission channel is available or not before performing a transmission, and only when the transmission channel is judged as available, it sends out a signal. Each of the terminals has a function of detecting the occurrence of a signal collision. When a collision occurs, all the terminals that are attributable to the collision halt the transmission and withhold the transmission for a wait time determined by random numbers, and thereafter, they attempt a retransmission.

However, in a network in which individual terminals are unable to detect the occurrence of a collision on the communication channel, such as in a wireless LAN, it is difficult to adopt the above-described CSMA/CD system. As an arbitration system applicable to such a network, a CSMA/CA (Carrier Sense Multiple Access with Collision Avoidance) system is known. In this system, each terminal monitors the communication channel before starting to send out a signal, and checks whether or not a signal transmission is being carried out on the communication channel. Then, if no signal has been transmitted on the communication channel for a predetermined wait time or longer, a transmission of signal is started. The wait time is configured such that a random length of time is added to an invariable time, so as to prevent a situation in which a plurality of terminals start transmission all at once after a certain time has elapsed since the end of the most recent signal transmission, causing a collision.

In addition, upon receiving a transmitted signal, a receiving side terminal returns an ACK (Acknowledge) signal, which is a confirmatory response indicating that the signal has been properly received. The sending side terminal judges from the presence or absence of the ACK signal whether or not the transmitted signal has been properly transmitted, and if the response due to the ACK signal is absent, it judges that the transmission failed due to communication problems such as collisions or interference, so it resends the signal.

In the above-described CSMA/CD system, there is no priority order among the signals (packets) sent by the terminals, and all the signals are treated equally. In reality, however, there are cases in which, depending on contents of the packets to be transmitted, some packets have a higher priority than others when being transmitted. For example, in order to achieve QoS (Quality of Service) in communications in which signal delays or interruptions cannot be tolerated, such as in a real time distribution of moving images or sound, it is required that the data communication should be isochronous, and packets related to such communications should be transmitted/retransmitted with higher priorities.

In addition, in a so-called shared media network in which all the nodes share a communication channel, the nodes on the network basically have no priority orders and are equal. For example, when a relaying device for relaying communications between terminals is introduced for the purpose of extending the communication distance in the network, the relaying device is also regarded as a node that is equivalent to other terminals. Therefore, a collision may occur between a packet that the relaying device has sent out for a relay operation and a packet that has been sent out by another terminal, which makes the relay operation difficult to succeed. Thus, introduction of relaying devices is difficult, limiting the communication distance, which is also a problem.

### SUMMARY OF THE INVENTION

It is an object of the present invention to provide a method of controlling communications in a network in which a plurality of terminals share one communication channel, the method being capable of avoiding signal collisions and of transmitting a predetermined signal with high priority, and by which a relaying device can be easily introduced in the network.

According to the present invention, a network includes a plurality of terminals connected via a shared communication channel, and in each of the plurality of terminals, the following steps (a) through (e) are performed. The step (a) is to give a priority level to a first signal to be transmitted to another one of the plurality of terminals via the communication channel, the priority level being regulated in the network. The step (b) is to determine a first wait time having a length corresponding to the priority level. The step (c) is to monitor the communication channel to check whether a signal transmission is present on the communication channel. The step (d) is to send out the first signal, if the signal transmission is not detected during the first wait time in the step (c). The step (e) is to return to the step (b), if the signal transmission is detected during the first wait time in the step (c).

Even when a collision occurs in a signal transmission, it can be avoided by retransmission, and a signal having a higher priority level can be transmitted with high priority. The invention may be suitably applied to a terminal that does not have a function of detecting a signal collision in a communication channel. Moreover, it is unnecessary to provide a device such as a base station or a server for serving for arbitration of data transmissions between the terminals in a network. Furthermore, by giving a higher priority level to an ACK (Acknowledge) signal, which is a confirmatory response indicating that a signal from another terminal has been received, than other signals, the ACK signal can be reliably sent/received, and communication reliability is thus improved.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram for illustrating the relationship between priority levels of packets and slots in a first preferred embodiment.

FIG. 2 is a diagram for illustrating elementary slots in a slot according to the first preferred embodiment.

FIG. 3 is a diagram for illustrating a slot for an ACK signal in the first preferred embodiment.

FIG. 4 is a diagram for illustrating an example of a LAN configuration using PLC.

FIG. 5 shows diagrams for illustrating a method of controlling communications according to the first preferred embodiment.

FIG. 6 is a flowchart showing a packet transmission operation in a terminal according to the first preferred embodiment.

FIGS. 7 through 9 are diagrams for illustrating a method of controlling communications according to the first preferred embodiment.

FIG. 10 is a diagram for illustrating a slot for a relaying device in a second preferred embodiment.

FIG. 11 shows diagrams for illustrating a method of controlling communications according to the second preferred embodiment.

FIG. 12 is a flowchart showing a packet transmission operation in a terminal according to the second preferred embodiment.

FIG. 13 is a flowchart showing an operation of a relaying device according to the second preferred embodiment.

FIGS. 14 and 15 are diagrams for illustrating a method of controlling communications according to the second preferred embodiment.

### DESCRIPTION OF THE PREFERRED EMBODIMENTS

### First Preferred Embodiment

A method of controlling communications according to a first preferred embodiment is described below. Herein, a shared media network in which one communication channel is shared by all nodes is assumed, such as a wireless LAN or a LAN environment using PLC (Power Line Communication).

First, priority levels to be allocated to all the signals (packets) that are sent out by nodes (including terminals and relaying devices) on a network are commonly defined in the network. The priority levels may be assigned terminal by terminal, (that is, the packets sent by a given terminal always have the same priority level) or they may be assigned adaptively packet by packet (that is, the packets sent by a given terminal have any priority levels).

Then, a time slot (hereafter referred to as “slot”) that regulates timing for sending out a packet is allocated to each of the priority levels. Each slot is determined based on the timing at which a packet transmission on the communication channel finishes. The priority levels are allocated to slots in such a manner that packets having higher priority levels (packets to be transmitted with higher priority) are allocated to earlier slots.

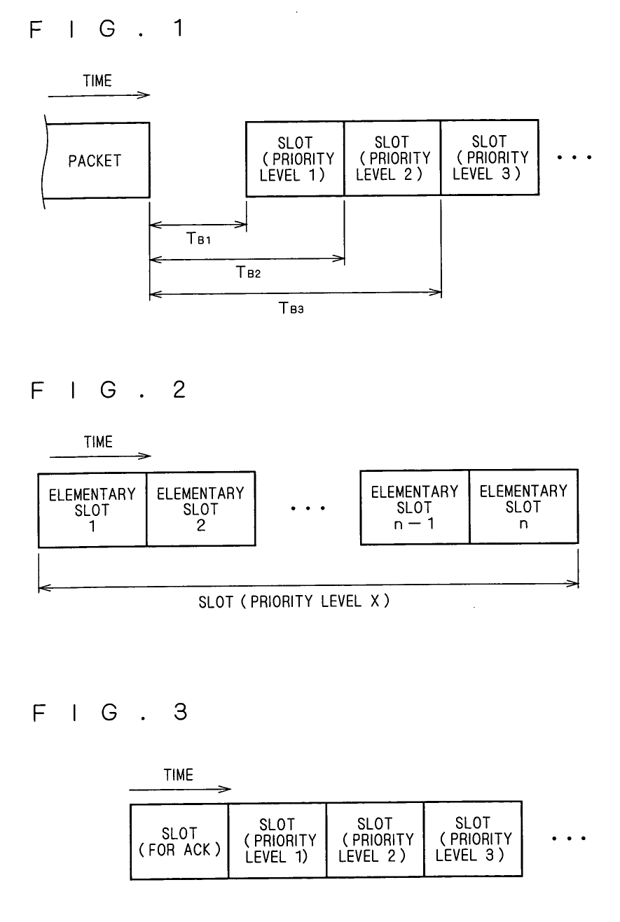

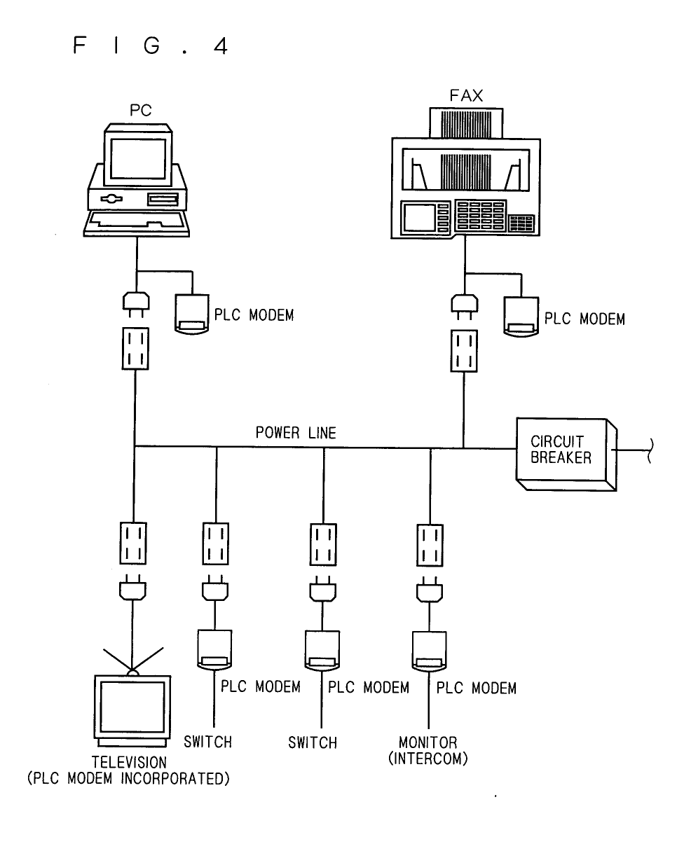

As shown in FIG. 1, a packet having “priority level 1”, which has the highest priority level, is allocated to the earliest slot that is determined taking the time at which the previous packet transmission finishes on the communication channel as a reference point. A packet having “priority level 2”, a packet having “priority level 3”, . . . , etc. are assigned to the respective subsequent slots so that those having higher priority levels are allocated earlier. Further, each of the slots shown in FIG. 1 is made up of n elementary slots having the same priority level, as shown in FIG. 2. It should be noted that, in the following description, a predetermined wait time (time T_{B1}, T_{B2}, T_{B3}, . . . etc. in FIG. 1) that is from a reference point time at which a previous packet transmission finishes on the communication channel to a time at which the next packet transmission is started, is referred to as a “backoff time”.

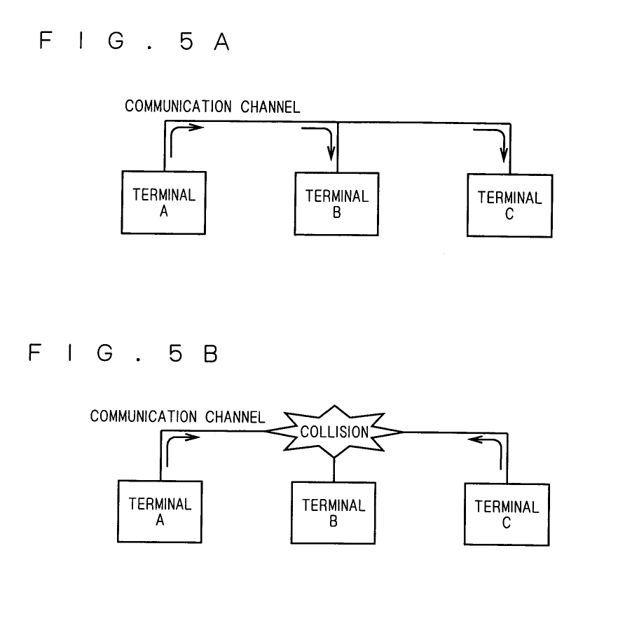

In a similar manner to the above-described CSMA/CA system, upon receiving a packet directed to itself, a receiving side terminal returns an ACK (Acknowledge) signal packet, which is a confirmatory response indicating that the packet has properly been received. A sending side terminal judges from the presence or absence of the response with the ACK signal whether or not the sent packet has been transmitted to the receiving side terminal properly. If the response with the ACK signal is absent, it judges that the transmission has failed, and it resends the signal. In the present embodiment, the ACK signal is treated as a packet having the highest priority level. Accordingly, as shown in FIG. 3, a slot for the ACK signal is assigned to be the slot having the earliest timing. In other words, the backoff time corresponding to the slot for the ACK signal is set to be shorter than those of the slots for other packets.

A specific example of a method of controlling communications on a network according to the present preferred embodiment is described below. An example of the shared media network in which one communication channel is shared by all nodes is a LAN environment using PLC (Power Line Communication). FIG. 4 is a diagram showing an example of the configuration of a LAN using PLC. In the PLC, power lines that are wired for supplying power in general houses and office are utilized as communication channels. As shown in FIG. 4, a PC (personal computer), a fax machine, a television, switches for lighting apparatuses or the like, a monitor of intercom, and so forth function as communication terminals by connecting PLC modems thereto (or by incorporating them therein). The terminals are connected to one another via a power line, which serves as a communication channel, and information such as control signals can be sent/received one another. Thus, it becomes possible, for example, to use a PC to control other appliances.

The PLC makes it possible to use a general power outlet as a connector for connecting to a network, and for this reason, it has drawn attention as it is a technology for spreading telecommunication networks among homes and offices. For example, because power outlets are provided almost every room in homes, it will be very convenient if they can be used as connectors for connecting to a LAN.

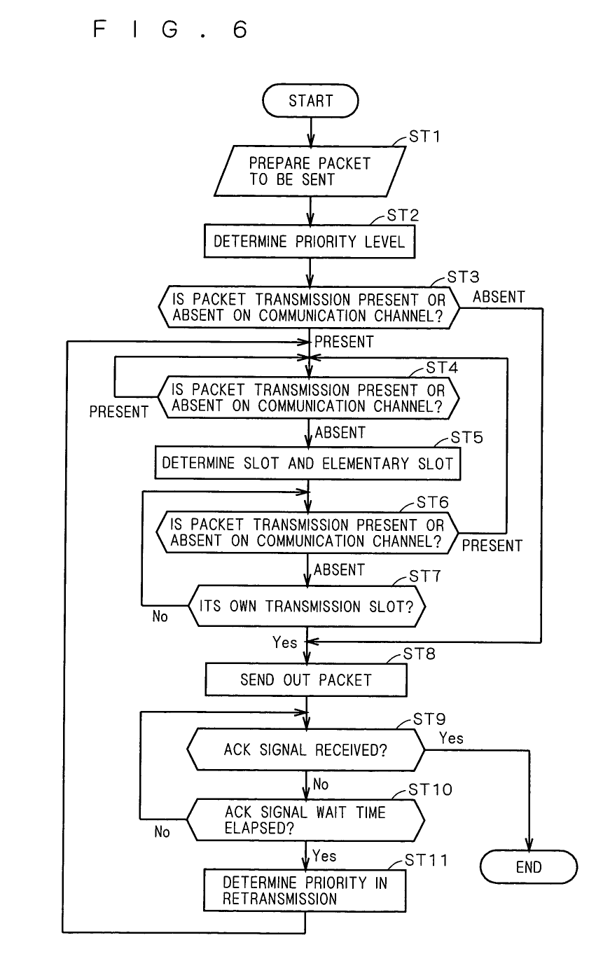

For the sake of simplicity in explanation, the present preferred embodiment assumes a network in which, as shown in FIG. 5(a), three terminals A, B, and C are connected to a common communication channel (which corresponds to a power line in the case of PLC). The terminals A, B, and C are within a distance such that they can communicate with one another without using a relaying device. The network is a shared media network, and for this reason, while a certain terminal is transmitting a packet, the rest of the terminals cannot send out a packet. For example, if the terminals A and C attempt to send out packets simultaneously, a collision occurs as shown in FIG. 5(b), and consequently, data communication cannot be performed properly. It should be noted that when the terminals A, B, and C receive packets from other terminals properly, they return an ACK signal packet as a confirmatory response thereto.

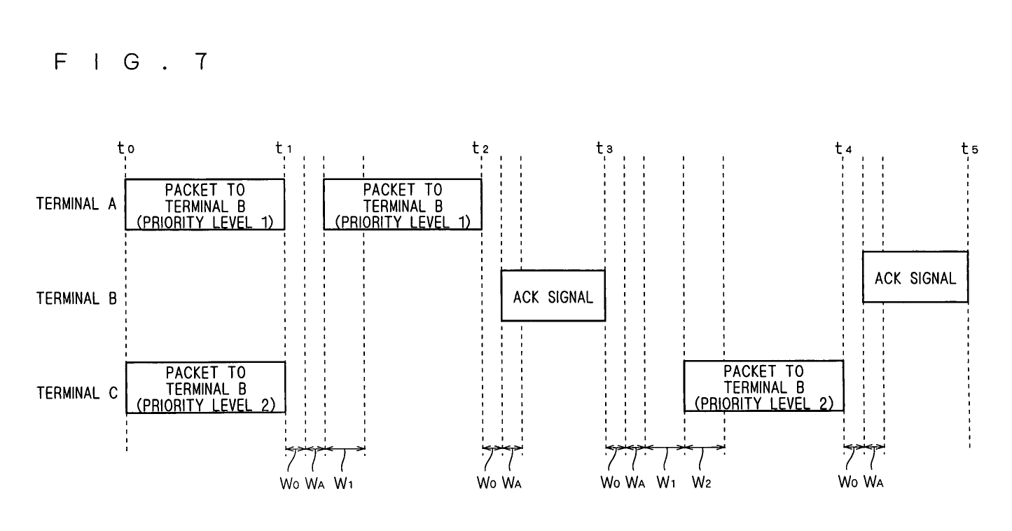

FIG. 6 is a flowchart showing a packet transmission operation in a terminal according to the present preferred embodiment. In the case where a terminal transmits a packet as a first signal, which is a subject to be sent out, to another terminal via a communication channel, the terminal first prepares the packet (ST1), and then, it gives a priority level that is regulated in the network to the packet (ST2). Here, when priority levels are assigned terminal by terminal, data indicating the priority levels are stored in a ROM in each of the terminals, and the process of step ST2 is performed by having the terminal itself refer to the stored data. On the other hand, when the priority levels are assigned adaptively packet by packet, the process of step ST2 is performed by, for example, identifying the application (software) that handles the packet to be transmitted. In other words, by finding which application handles the packet, it is possible to find the importance of that packet, such as real-timeness; for this reason, a priority level is determined for each of the applications in advance, and the packet to be transmitted is given a priority level corresponding to the application that handles that packet.

Subsequently, the terminal monitors the communication channel to check if a packet transmission is present or absent on the communication channel (ST3). In this step, if a packet transmission is not detected on the communication channel (that is, if the communication channel is idle), the terminal immediately sends out the packet (ST8).

On the other hand, if a packet transmission is detected on the communication channel (that is, if the communication channel is in use), the terminal waits until it is completed (ST4). Then, a slot and an elementary slot for sending the packet are allocated (ST5). At this time, a slot corresponding to the priority level of the packet is first allocated, and then, in that slot, an elementary slot selected based on a random number (randomly) is allocated.

Thereafter, the terminal continues to monitor the communication channel until the elementary slot allocated to the packet that it will send out (hereafter referred to as “its own transmission slot”), is reached (ST6, ST7), and if a packet transmission from another terminal is not detected by the time its own transmission slot is reached, the terminal carries out a transmission of the packet (ST8). Accordingly, the time between the end of the previous packet transmission and its own transmission slot (i.e., a backoff time of its own transmission slot) corresponds to a first wait time.

If a packet transmission from another terminal is detected by the time of its own transmission slot, the terminal does not perform its packet transmission and the process returns to the foregoing step ST4, because the terminal cannot perform a packet transmission until the ongoing transmission finishes (a collision occurs if a packet transmission is performed). Then, the foregoing steps ST4 through ST7 are repeated until the packet can be transmitted.

The backoff time of its own transmission slot, which is the first wait time, is the sum of an invariable backoff time of the slot that is determined corresponding to its priority level (a first elementary time) and a time from the start of that slot to when a predetermined elementary slot is reached (a second elementary time). Because the elementary slot in the slot is selected based on a random number, the length of the second element time is determined based on a random number.

Packet transmission timing in each of the terminals is such that ones having higher priority levels are allocated to earlier slots in sequence, and therefore, packets are transmitted from those having higher priority levels in sequence. In addition, even if there are a plurality of packets having the same priority level, the occurrence of collisions is suppressed because the packets are allocated to the respective elementary slots that are randomly determined.

The terminal that has sent out the packet awaits a response with the ACK signal from a receiving side terminal for a predetermined ACK signal wait time (a second wait time) (ST9, ST10). The ACK signal wait time is defined to be a period of time including a time at which the ACK signal is to be received in the case where the packet transmission is performed properly. In the present preferred embodiment, the ACK signal wait time is a backoff time of the slot having a priority level of 1 after a packet transmission.

If an ACK signal is received in the ACK signal wait time, the terminal ends the operations concerning the packet transmission. By contrast, if the ACK signal is not received, the previous transmission is regarded as having failed, and the process returns to step ST4 to attempt a retransmission of the packet. At this time, the packet is given a priority level for the retransmission (ST11). The priority level for the retransmission is made the same as the priority level in the previous transmission.

As described above, if the communication channel is used by another terminal, each of the terminals waits until the communication (the packet transmission) finishes and the communication channel becomes available, and thereafter, it carries out a transmission of the packet. In many cases, collisions can be avoided by this operation. However, when the communication channel is congested, there are cases in which a plurality of terminals start a packet transmission at the same time, causing a collision. For example, a collision is caused when a plurality of terminals perform the judgment of step ST3 at the same time, or when a plurality of terminals coincidentally allocate the same elementary slot to its own transmission slot.

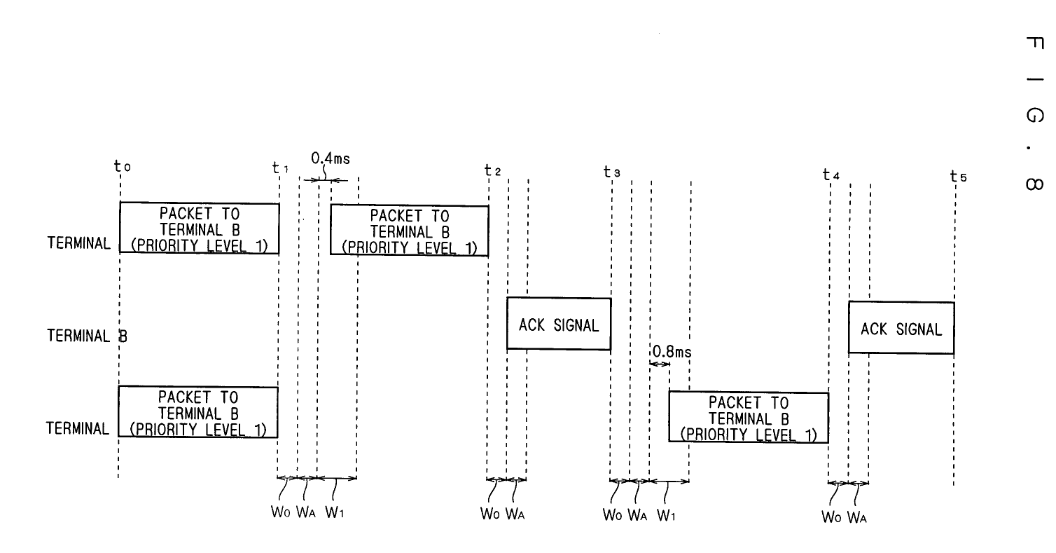

Even when such a collision occurs, the terminal according to the present preferred embodiment is able to avoid the collision by means of retransmission. For example, in the network shown in FIG. 5(a), it is assumed that, at time to as shown in FIG. 7, a terminal A carried out a transmission of a packet (priority level 1) to a terminal B at the same time as a terminal C carried out a transmission of a packet (priority level 2) to the terminal B, thus causing a collision. With this collision, the terminal B can receive neither the packet from the terminal A nor the packet from the terminal C properly. Accordingly, the terminal B does not perform a transmission of the ACK signal. In the figure, a period W_{A} indicates a slot for the ACK signal, and a period W₀ indicates a backoff time for the slot W_{A}. A period W₁ indicates a slot for a packet having a priority level of 1, and a period W₂ indicates a slot for a packet having a priority level of 2.

After having sent a packet, each of the terminals A and C awaits an ACK signal for the ACK signal wait time (backofftime of slot W₁) (ST9, ST10). However, because the ACK signal from the terminal B is not received even when the slot W_{A} for the ACK signal in the ACK signal wait time is reached, the terminals A and C carry out a process for the retransmission. At this time, the same priority level as that in the previous transmission is given to the packet that is to be retransmitted (ST11).

The terminals return to the operation of the foregoing step ST4. As shown in FIG. 7, the communication channel is idle after a time t₁, at which the transmissions from the terminals A and C finish, and therefore, each of the terminals A and C determines a slot and an elementary slot for the retransmission (ST5). Since the same priority level as that in the previous transmission is given in the retransmission, the terminal A allocates a slot W₁ having a priority level of 1 whereas the terminal C allocates a slot W₂ having a priority level of 2. It should be noted that the elementary slots in the slots W₁ and W₂ are determined based on random numbers but they are not elaborated upon for simplicity in explanation.

For example, it is assumed that the length of the slot W_{A} is 0.8 ms, the backoff time W₀ thereof is 1.0 ms, and the length of the slots W₁ and W₂ is 1.6 ms. In this case, the terminal A determines the backoff time of its own transmission slot to be 1.8 ms, and likewise, the terminal C determines the backoff time of its own transmission slot to be 3.4 ms.

Thereafter, the terminals A and C continue to monitor the communication channel until their own transmission slots are reached (ST6, ST7). The terminal A resends the packet since a packet transmission from another terminal is not detected during the backoff time of its own transmission slot W₁ (ST8). On the other hand, the terminal C returns to step ST4 since it detects the packet transmission due to the retransmission from the terminal A.

Having received the packet from the terminal A, the terminal B sends out an ACK signal in a slot W_{A} that is after a time t₂, at which the transmission of that packet has finished. At this time, since the ACK signal has a higher priority level than other signals, it is sent out earlier than the slots for other signals. As a consequence, no collision occurs when the ACK signal is sent, and the ACK signal can be reliably received by the terminal A. Having received the ACK signal from the terminal B, the terminal A ends the operations concerning its packet transmission. In the meantime, since the communication channel temporarily becomes idle at the time t₂, the terminal C enters the operations of steps ST5 to ST7. However, because it detects the transmission of the ACK signal packet in a slot W_{A} that is before entering the slot W₂ (ST6), it returns step ST4 again and waits until the communication channel becomes idle.

Then, after a time t₃, at which the terminal B finishes sending the ACK signal, the terminal C monitors the communication channel during the backoff time of its own slot W₂ (ST5 to ST7), and resends the packet in the slot W₂ because it does not detect a packet transmission (ST8).

Having received the packet from the terminal C, the terminal B sends out an ACK signal packet in a slot W_{A} that is after time t₄, at which the transmission of the foregoing packet has finished. Having received the ACK signal from the terminal B, the terminal C ends the operations concerning its packet transmission. Thus, as described above, even if a collision occurs at one point, it is possible to avoid subsequent collisions in the retransmission, and therefore, packet communications can be performed reliably between the terminals.

Next, it is assumed that, as shown in FIG. 8, a collision occurred at time to between packets both having a priority level of 1. In this case as well, the terminals A and C perform a retransmission process after the time t1 at which their packet transmissions have finished, since they do not receive the ACK signal from the terminal B even when the slot W_{A} for the ACK signal is reached. At this time too, the same priority level as that in the previous transmission is given to the packet that is to be retransmitted.

The packets sent by the terminals A and C both have a priority level of 1, and therefore, in the retransmission, the terminals A and C both allocate the slot W₁ to its own slot. Further, the terminals A and C allocate elementary slots in the slot W₁ based on random numbers.

For example, it is assumed that the length of the slot WA is 0.8 ms, the backoff time W₀ thereof is 1.0 ms, and the length of the slot W₁ is 1.6 ms. It is also assumed that, in the slot W₁, there exist four elementary slots, each of which has a length of 0.4 ms. Since the terminals A and C select one of the four elementary slots in the slot W₁ having a priority level of 1, the backoff time of each elementary slot is given by 1.8 ms+0.4 ms×N (N is an integer from 0 to 3). N represents a random number, but it is assumed herein that the terminal A selected an elementary slot corresponding to N=1 and the terminal B selected an elementary slot corresponding to N=2.

The terminals A and C monitor the communication channel until their own transmission slots are reached (ST6, ST7). The terminal A performs a retransmission after the time t₁ since no packet transmission is detected on the communication channel during the backoff time of its own transmission slot (1.8 ms+0.4 ms) (ST8). By contrast, the terminal C detects a packet transmission due to the retransmission by the terminal A, and returns to step ST4.

Having received the packet from the terminal A, the terminal B sends out the ACK signal in the a slot W_{A} after the time t₂, at which the transmission of that packet has finished. Having received the ACK signal from the terminal B, the terminal A ends the operations concerning its packet transmission. In the meantime, the terminal C enters the operations of step ST5 to ST7 since the communication channel temporarily becomes idle at the time t₂. However, since it detects the transmission of the ACK signal packet on the communication channel before its own transmission slot is reached, it returns to step ST4 and waits until the communication channel becomes idle.

Then, the terminal C carries out a retransmission since it detects no packet transmission on the communication channel from the time t₃, at which the terminal B finishes transmitting the ACK signal, to the backoff time of its own transmission slot (1.8 ms+0.8 ms).

Having received the packet from the terminal C, the terminal B waits for the backoff time W₀ from a time t₄, at which the transmission of that packet has finished, and thereafter, it transmits the ACK signal in the slot W_{A}. The terminal C receives the ACK signal from the terminal B and ends the operations concerning its packet transmission.

Thus, as described above, even when a collision occurs between the packets having the same priority level, it is possible to suppress the occurrence of collisions in retransmissions by providing a plurality of elementary slots in a slot corresponding to one priority level and selecting the elementary slots based on random numbers. The larger the number of the elementary slots provided in each slot, the less the probability of collisions is. Therefore, if, for example, the number of elementary slots that can be selected by a terminal in a retransmission is increased, the occurrence of collisions in retransmissions of packets can be suppressed, and the total number of times of retransmissions can be reduced.

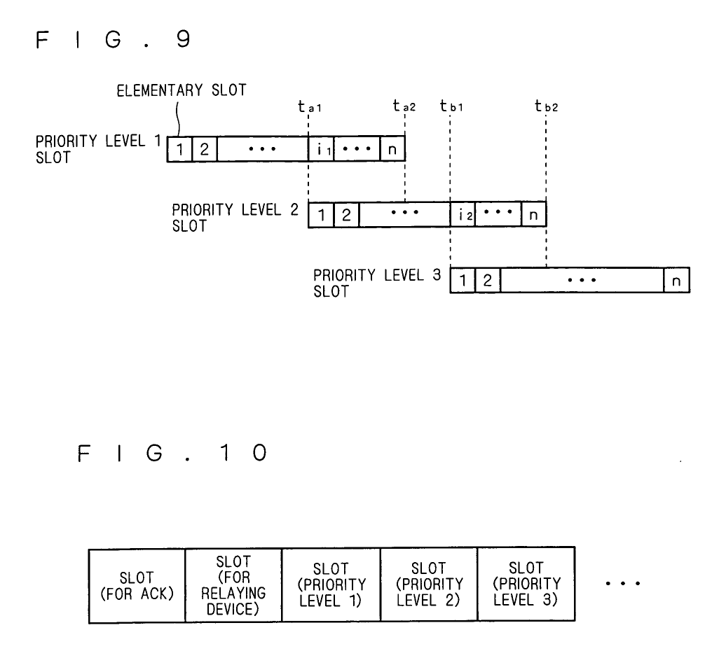

In the present preferred embodiment, if congestion of a communication line continues for a long time, it is conceivable that a packet having a low priority level is not transmitted for an infinitely long time. In order to avoid this situation, for example, as shown in FIG. 9, portions of slots having different priority levels may be overlapped one another so that a packet having a lower priority level can be given an opportunity to be sent out during a slot period having a higher priority level.

In an example shown in FIG. 9, timing of a portion of a slot having a priority level of 2 overlaps with timing of a portion of a slot having a priority level of 1 Specifically, during the overlapped period, which is between a time tₐ₁ and a time tₐ₂, an elementary slot i₁ to an elementary slot n that have a priority level of 1 overlap an elementary slot 1 to an elementary slot (n−iᵢ+1) that have a priority level of 2, respectively. Likewise, a slot having a priority level of 3 overlaps the slot having a priority level of 2 between a time t_{b1} and a time t_{b2}. Specifically, during that period, an elementary slot i₂ to an elementary slot n that have a priority level of 2 overlap an elementary slot 1 to an elementary slot (n−i₂+1) that have a priority level of 3, respectively.

As a result, an opportunity to send out the packet having a priority level of 2 is given even in the period of the slot having a priority level of 1, and an opportunity to send out the packet having a priority level of 3 is given even in the period of the slot having a priority level of 2. Thus, the occurrence of the situation in which a packet having a lower priority cannot be sent out for an infinitely long time is suppressed. It should be noted that, if this configuration is adopted, it is conceivable that a collision occurs between packets having different priority levels, but even in such cases, collisions are avoided by means of retransmission according to the method of controlling communications of the present preferred embodiment, which has been explained referring to the flowchart of FIG. 6. Specifically, even if a collision occurs between packets having different priority levels, the ACK signal does not come back in step ST9 to the terminals that have sent out those packets; therefore, the process proceeds to step ST11, and a retransmission process is performed.

As described above, the present preferred embodiment makes it possible to avoid a collision in packet transmissions, if it occurs, by means of retransmission, and to send out a packet having a higher priority level with high priority. In addition, the present preferred embodiment can be adopted to terminals that do not have a function of detecting signal collisions on a communication channel. Moreover, it is unnecessary to provide such a device as a base station or a server for arbitrating data transmission between the terminals on a network.

Furthermore, by making the priority level of the ACK signal higher than those of other signals, the ACK signal can be reliably sent and received, whereby communication reliability is improved. For example, a LAN using PLC tends to produce large noises and therefore its communication quality is relatively low (many errors are caused); however, by adopting the present invention, it can be treated in a similarly way to Ethernet (registered trademark), which has high communication quality. For example, in the OSI (Open Systems Interconnection) reference model, if the ACK signal can reliably be sent and received and thereby communication reliability can be increased in layer 2 or lower (e.g., in PLC modems or the like), the need for providing confirmatory responses in layer 3 or above is eliminated.

### Second Preferred Embodiment

The first preferred embodiment has described a case in which the terminals on a network are within such a distance that they can communicate with one another without using a relaying device. The second preferred embodiment considers a case in which a relaying device is introduced in a network according to the present invention. In a shared media network such as a LAN using PLC, relaying devices are also considered as nodes that are equivalent to terminals. In other words, in order for a relaying device to relay packets, the relaying device needs to receive the packets completely and send them thereafter, as in the case of normal terminals.

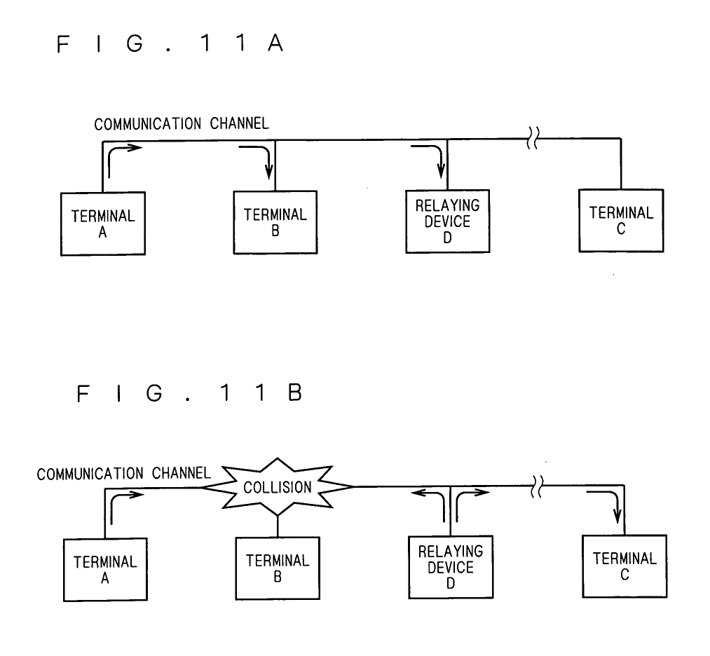

In the present preferred embodiment, an invariable priority level is provided for packets transmitted by a relaying device further in the method of controlling communications described in the first preferred embodiment. A packet sent out by the relaying device is treated a packet having the next highest priority to that of the ACK signal packet. Specifically, as shown in FIG. 10, a slot in which the relaying device sends out a packet is allocated to the next earliest slot to the slot for the ACK signal. That is, the backoff time corresponding to the slot for the relaying device is set to be shorter than those of slots for other packets that exclude the ACK signal.

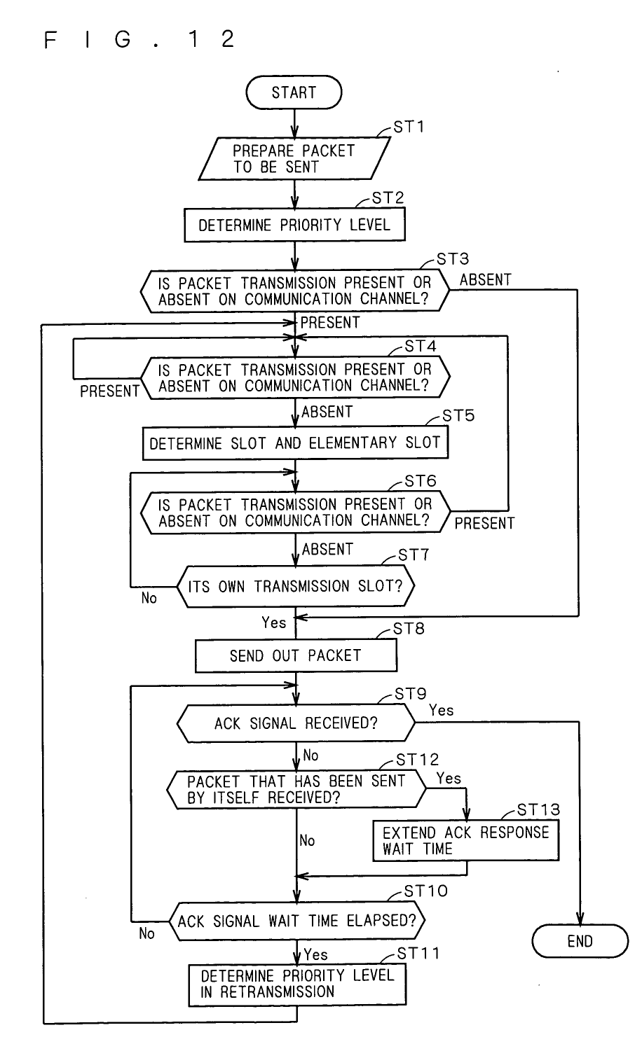

For simplicity in explanation, the present preferred embodiment assumes a network in which, as shown in FIG. 11(a), terminals A, B, and C as well as a relaying device D are connected to a shared communication channel. The terminal A and B are within a distance such that they can communicate with each other without using a relaying device D, whereas communications with the terminal C require a relay operation by the relaying device D. Packets transmitted from the relaying device D for relaying are not distinguished from the packets transmitted from other terminals, so if they are sent out at the same time as those from other terminals, a collision occurs as shown in FIG. 11(b).

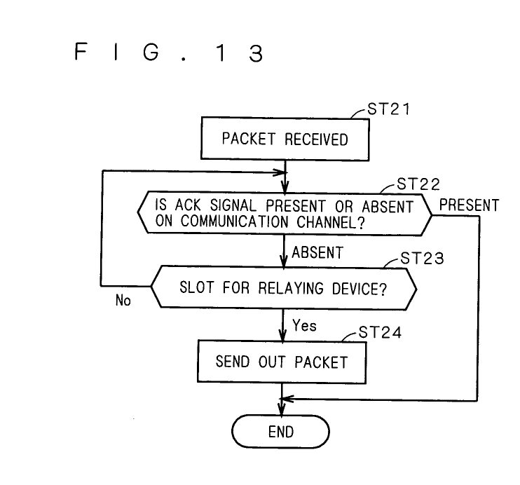

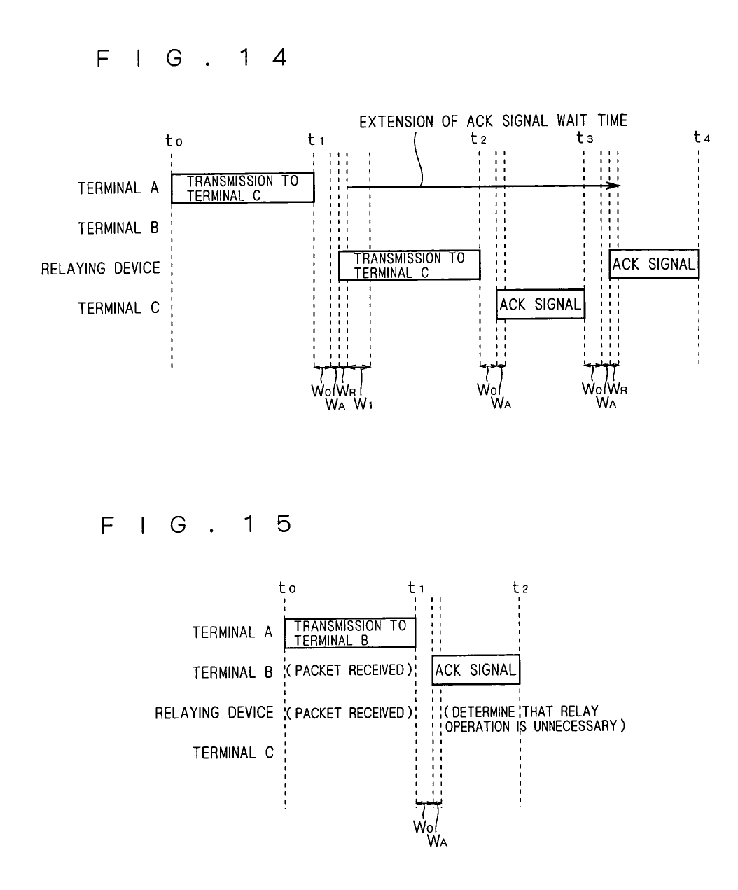

FIGS. 12 and 13 are flowcharts showing the operations of a terminal and of a relaying device, respectively. In FIG. 12, similar steps to those of FIG. 6 are denoted by like reference characters. As will be appreciated from FIG. 12, the operations of steps ST1 through ST8 are similar to those in the first preferred embodiment and therefore not elaborated upon further herein, and the operations following the packet transmission in step ST8 will be described below.

For example, it is assumed that, in a network as shown in FIG. 11(a), the terminal A performs a packet transmission to the terminal C at a time t₀. In the figure, a period W_{A} indicates a slot for the ACK signal, and a period W₀ indicates a backoff time for the slot W_{A}. A period W_{R} indicates a slot for a relaying device, a period W₁ indicates a slot for a packet having a priority level of 1, and a period W₂ indicates a slot for a packet having a priority level of 2.

The packet sent out from the terminal A does not reach the terminal C, but is received by the relaying device D. As shown in FIG. 13, upon receiving the packet (ST21), the relaying device D monitors the communication channel for the backoff time (a third wait time) of the slot W_{R} for the relaying device after the time t₁, at which the packet transmission has finished, to detect whether the ACK signal is present or absent (ST22). Since the packet sent from the terminal A does not reach the terminal C, the receiving side terminal C does not send out the ACK signal. Accordingly, the relaying device D does not detect the ACK signal, and when the slot for the relaying device is reached, it sends out the packet that has been received previously (ST23, ST24).

Meanwhile, after having sent out the packet, the terminal A awaits the ACK signal for a predetermined ACK signal wait time (a fourth wait time). At this point, the terminal A sets the ACK signal wait time to be the backoff time of a slot having a priority level of 1 that is after the packet transmission. The ACK signal is not received by the terminal A even when the slot W_{A} for the ACK signal is reached that is in the ACK signal wait time, but instead, the packet sent out by the relaying device (that is, the packet previously sent out by the terminal A itself) is received in the slot W_{R} for the relaying device. As shown in FIG. 12, upon receiving the packet sent by itself during the ACK signal wait time (ST12), the terminal A extends the ACK signal wait time by a predetermined time length (ST13) and further awaits the ACK signal. In this step, the ACK signal wait time is extended at least to a time at which the ACK signal, serving as a response to the packet transmission via the relaying device, is to be received by the sending side terminal.

The packet sent out by the relaying device D is received by the terminal C, and the terminal C sends out an ACK signal packet in the slot W_{A}. The ACK signal packet from the terminal C is received by the relaying device D, and the relaying device D sends out the ACK signal packet in the slot W_{R} for the relaying device. In the foregoing step ST13, the terminal A needs to extend the ACK signal wait time at least to the timing of the slot W_{R} for the relaying device after the time t₃. Having received the ACK signal from relaying device D, the terminal A judges that the previously sent packet has been received by the terminal C properly, and it ends the operations concerning its packet transmission.

Next, the following describes the operations in cases where the relaying device receives a packet that does not require a relay operation. For example, it is assumed that in a network as shown in FIG. 11(a), the terminal A sends a packet to the terminal B, as shown in FIG. 15. The packet sent out from the terminal A is received by the terminal B without going through the relaying device. Meanwhile, that packet is also received by the relaying device D. As shown in FIG. 13, upon receiving the packet (ST21), the relaying device D monitors the communication channel for the backoff time of the slot W_{R} for the relaying device after the time t₁, at which the packet transmission has finished, to detect whether the ACK signal is present or not (ST22). In the example of FIG. 15, upon receiving the packet, the terminal B sends out the ACK signal. Consequently, in step ST22, the relaying device D detects the ACK signal and judges that the previously received packet does not need a relay operation, so it does not send out the packet and ends its operation.

As described above, the present preferred embodiment makes it possible to avoid collisions in retransmissions and to transmit a packet having a higher priority level with high priority as in the first preferred embodiment, even in the case where a relaying device is introduced. In other words, by introducing a relaying device, communication distance can be easily extended. In addition, prior to the packet transmission, if the relaying device receives an ACK signal, it judges that a relay operation is unnecessary and does not send out a packet; therefore, it is possible to suppress the occurrence of signal collisions or the congestion of a communication channel arising from unnecessary relay operations.

In the foregoing preferred embodiments, a LAN using PLC has been taken as an example, but the present invention may be suitably applied to other kinds of networks (for example, a wireless LAN or the like).

While the invention has been shown and described in detail, the foregoing description is in all aspects illustrative and not restrictive. It is therefore understood that numerous other modifications and variations can be devised without departing from the scope of the invention.

What is claimed is:

1. A method of controlling communications for a network in which a plurality of terminals are connected via a shared communication channel, said method performed by each of said plurality of terminals and comprising the steps of:
(a) giving a priority level to a first signal to be transmitted to another one of said plurality of terminals via said communication channel, said priority level being regulated in said network;
(b) determining a first wait time having a length corresponding to said priority level;
(c) monitoring said communication channel to check whether a signal transmission is present on said communication channel;
(d) sending out said first signal, if said signal transmission is not detected during said first wait time in said step (c); and
(e) returning to said step (b), if said signal transmission is detected during said first wait time in said step (c).

2. The method according to claim 1, wherein said first wait time is a sum of a predetermined first elementary time that is determined corresponding to said priority level and a second elementary time that is determined based on a random number.

3. The method according to claim 1, wherein:
said each of said plurality of terminals is capable of sending, as said first signal, an ACK (Acknowledge) signal, which is a confirmatory response indicating that a signal from another one of said plurality of terminals has been received; and
said first wait time corresponding to said priority level of said ACK signal is shorter than those corresponding to priority levels of other signals.

4. The method according to claim 3, wherein said each of said plurality of terminals further performs the step of (f) returning to said step (a) or said step (b), if said ACK signal is not received from another one of said plurality of terminals when a predetermined second wait time has elapsed after said first signal excluding said ACK signal was sent out in said step (d).

5. The method according to claim 3, wherein:
a relaying device for transmitting a signal from one of said plurality of terminals to another one of said plurality of terminals is further connected to said communication channel, said relaying device performing the steps of:
(g) monitoring said communication channel after receiving a second signal from said one of said plurality of terminals to check if said ACK signal is present on said communication channel; and
(h) sending out said second signal to said another one of said plurality of terminals, if said ACK signal is not detected during a predetermined third wait time in said step (g); and
said third wait time is shorter than said first wait time corresponding to said priority levels of other signals, which exclude said ACK signal.

6. The method according to claim 5, wherein said each of said plurality of terminals performs the steps of:
(i) returning to said (a) or said step (b), if said ACK signal is not received from said another one of said plurality of terminals when a predetermined fourth wait time has elapsed after having sent out said first signal excluding said ACK signal in said step (d); and
(j) extending said fourth wait time by a predetermined time length if said first signal that has been sent from itself in said step (d) is received during said fourth wait time.
